(19) United States
(12) Patent Application Publication
(10) Pub. No.: US 2007/0081346 A1
(43) Pub. Date: Apr. 12, 2007

(54) Apparatus for remotely turning on and off lighting devices

(76) Inventor: Antonio Spinello, Laiano di Cascina (IT)

Correspondence Address: KNOBBE MARTENS OLSON & BEAR LLP, 2040 MAIN STREET, FOURTEENTH FLOOR, IRVINE, CA, 92614, US

(21) Appl. No.: 10/557,060

(22) PCT Filed: May 17, 2004
(86) PCT No.: PCT/IB04/01577

§ 371 Date: Dec. 11, 2006

(30) Foreign Application Priority Data
May 15, 2003 (IT) PI2003A000033

(51) Int. Cl. F21V 23/04; G08C 19/00

(52) U.S. Cl. 362/394; 340/825.72

(57) ABSTRACT

Lighting device (1) installable on a light bulb (12), or a bulb socket, which can be operated by any remote control, for example an IR remote control (5) of a TV set. The device (1) comprises at least one receiver (20) capable of detecting an IR code sent by the remote control (5). A memory stores the code and switching means turn on or off the lighting device at each following code transmitted by the remote control (5).

### FIELD OF THE INVENTION

The present invention relates to the field of lighting, and in particular it relates to a system for remotely switching lighting apparatus.

### BACKGROUND OF THE INVENTION

As known, lighting apparatus installed in public and private buildings provide usually an electric circuit feeding one or more light sources, such as ceiling, wall, floor lamps, etc., which are electrically connected to one or more ON/OFF switches by means of cables, which can be embedded in the building walls. For turning on/off the lighting apparatus of traditional type the user has to go to the switch. In case of wide rooms, such as for example public places, cinema, gymnasium, etc., the user can be quite far off the switch.

Lighting apparatus also exist operated by a dedicated remote control that allows turning on/off the light source from a distance. Such apparatus comprise a wall infrared (IR) receiver facing the environment to illuminate and connected electrically to the light source. The user then operates the apparatus by a remote control. It is also possible, with dedicated remote controls, to turn on/off each single light source.

However, when such lighting apparatus are not installed at the construction of the building, they involve expensive work to lay the electric cables.

### SUMMARY OF THE INVENTION

It is therefore a feature of the present invention to provide a lighting device that can be operated by whichever remote control, for example a TV remote control, and that can be applied to existing lighting apparatus.

It is also a feature of the present invention to provide such a lighting device that is structurally easy and cheap.

These and other features are accomplished with one exemplary lighting device, according to the present invention, as defined by the attached claims 1-11.

According to another aspect of the invention a method for turning on/off a light source by a remote control, said light source being equipped with a turning on/off circuit defined by the attached claims from 12 to 17.

### BRIEF DESCRIPTION OF THE DRAWINGS

Further characteristics and advantages of the present invention will be made clearer with the following description of possible exemplary embodiments, with reference to the attached drawings, in which like reference characters designate the same or similar parts throughout the figures of which:

FIG. 1 shows diagrammatically a perspective view of a lighting device, according to the invention, and furthermore, shows the possibility of operating the device with whichever remote control;

FIGS. 2A and 2B show a type of receiver that can be used in the device of-figure 1;

FIG. 3 shows diagrammatically an elevational front view of the operation of a possible exemplary embodiment of the device of FIG. 1;

FIG. 4 shows diagrammatically in a perspective elevational front view the operation of an exemplary embodiment alternative to that of FIG. 1;

FIG. 5 shows diagrammatically a perspective view of the possibility of using a same remote control for operating different light sources;

FIG. 6 shows a possible electric diagram of an IR receiver circuit for turning on/off the light source;

FIG. 7 shows a possible flow-sheet of a method for turning on/off a light source by a remote control, according to the invention.

FIG. 8 shows a flow-sheet alternative to that of FIG. 7.

FIG. 9 shows a preferred turning on/off circuit associated to a lighting device according to the invention;

FIGS. 10 and 11 show respectively a pulse-code and a diagram for sampling said code;

FIG. 12 shows an advantageous flow-sheet of the procedure of reading the code;

FIG. 13 shows a lighting device according to the invention which can be associated to the feeding cable of a lamp;

FIG. 14 shows a lighting device according to the invention which can be associated to the feeding fitting of a ceiling lamp;

FIGS. 15-17 show a lighting device according to the invention which can be associated to a light bulb;

### DESCRIPTION OF A PREFERRED EXEMPLARY EMBODIMENT

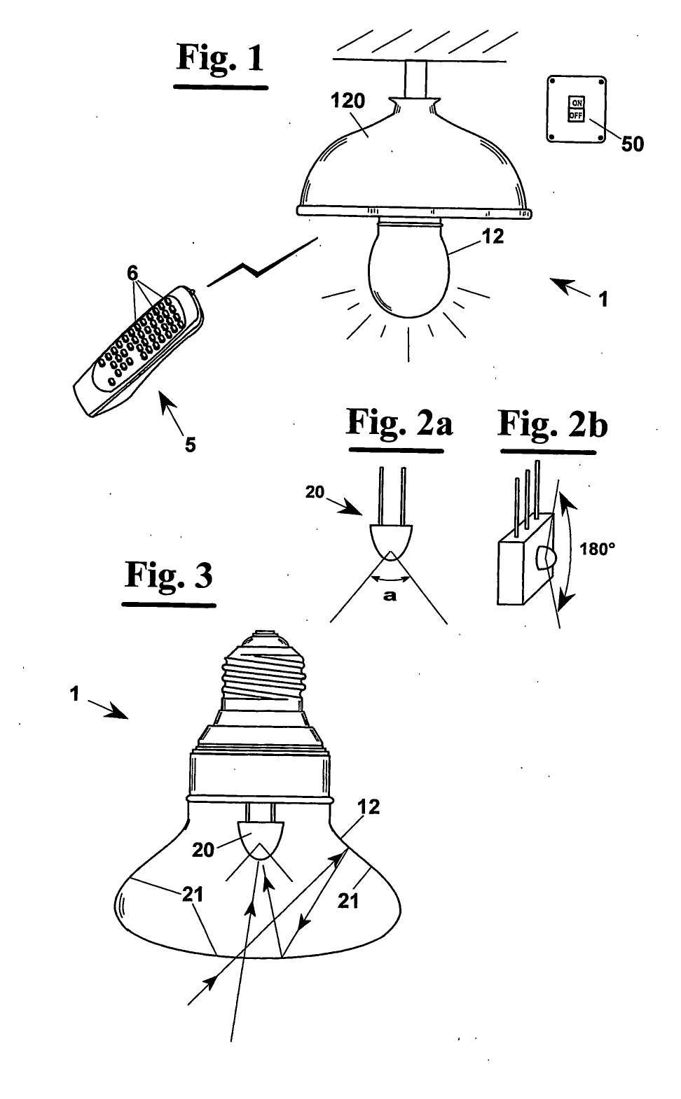

With reference to FIG. 1 a lighting device 1, according to the present invention, can be operated by whichever remote control, for example a remote control 5 of a TV set. Device 1 can be associated to a light bulb 12. In this case, the light bulb 12 can be fitted on a desired type of lamp 120 without that the latter has to be modified in any part thereof, in order to use the lighting device with any existing lamps.

Alternatively, the lighting device 1 can be mounted on board of a bulb socket. In this case the light bulb 12 can be of common type.

Some of the essential elements of the lighting device 1 will be described below, and then a more, detailed description will follow of the circuit in it integrated. Lighting device 1 comprises a receiver 20 capable of detecting an IR code sent by remote control 5 if this is oriented within a determined cone whose angle begins at the vertex a (FIG. 2). A memory is provided, for example an EEPROM, capable of keeping the data even without electric voltage, for recording this code and turning on/off means are provided for switching the lighting device at each successive detection of an admissible code transmitted by the remote control 5.

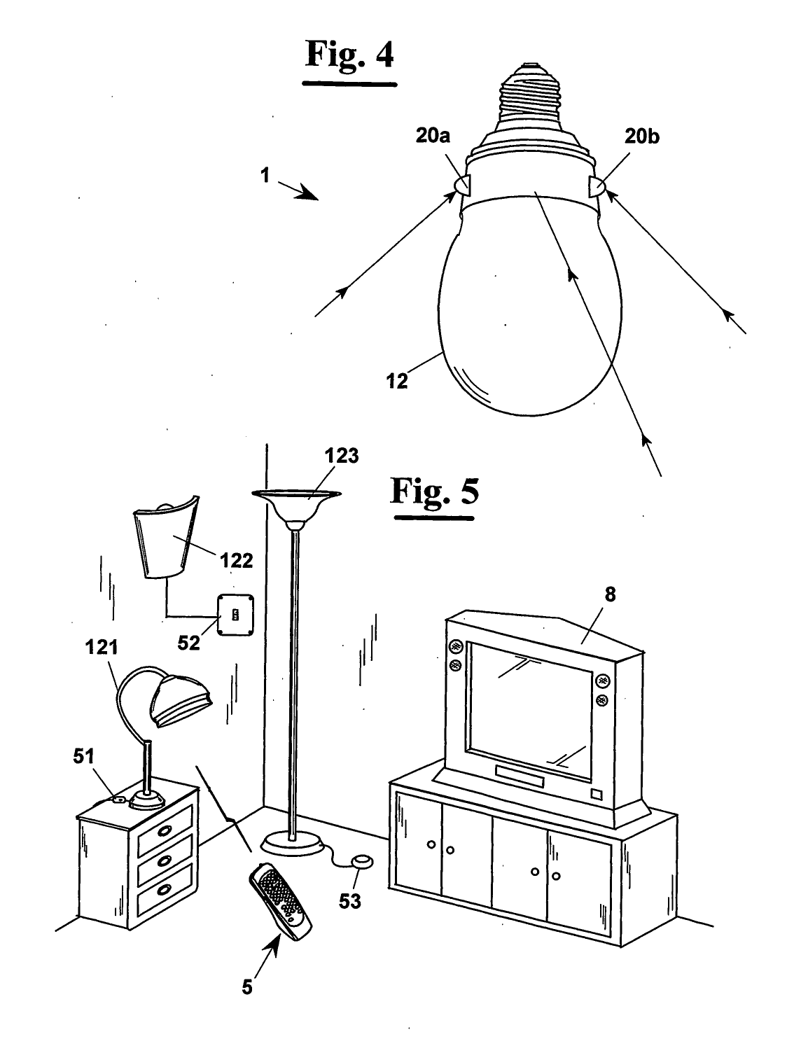

In particular, the device can comprise a single receiver 20 associated to optical surfaces 21 that deflect the infrared waves sent by the remote control 5 at the receiver 20 same (FIG. 3). Alternatively, several receivers 20 are provided, for example three receivers 20a, 20 b and 20c arranged at an angular distance of about 120° (FIG. 4).

In both cases, a preliminary step is provided of activating device 1 when voltage is supplied to lamp 120, for example a bedside table lamp 121, a wall lamp 122, a floor lamp 123, etc., by a respective manual switch 51, 52 or 53 (FIG. 5). At this point by remote control 5 of a TV set 8 an IR code is sent that can be the same for all lamps 120 or it can be different for each of them. In particular, to each key 6 an IR code corresponds and then for turning on or off lamps 121-123 at the same time, it is sufficient to set a same code in all the devices 1 mounted on them using a same key 6. On the contrary, for each lamp 121-123 a different key 6 and, then, a different code, is used.

More in detail, when a key 6 of remote control 5 is pressed, the means for recording device 1 enters in a self-learning loop that lasts a predetermined time, at the end of which the IR code is recorded and cannot be modified until device 1 is again in a self-learning mode.

Furthermore, it is also possible to change the intensity of the light source as described hereafter.

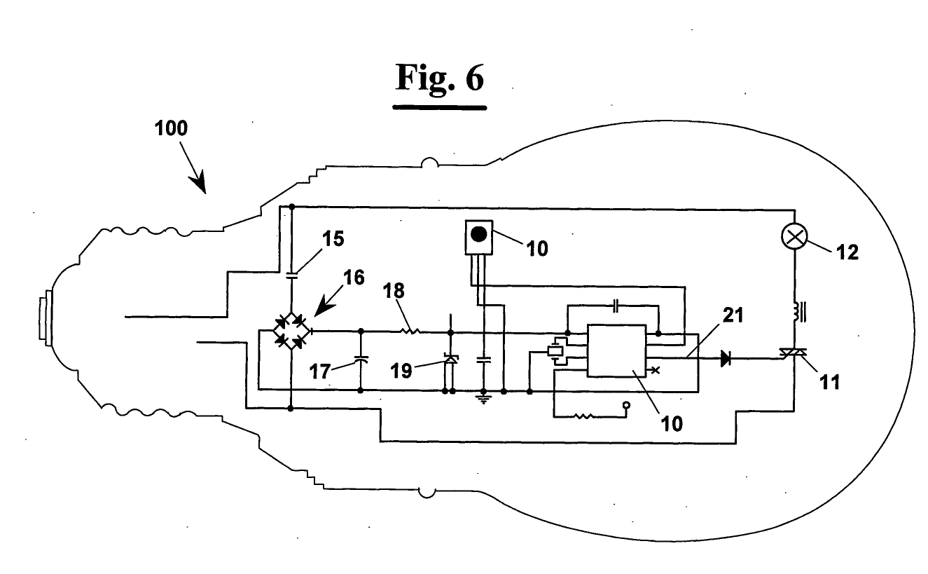

With reference to FIG. 6, a possible circuit 100 will be now described that can be used in device 1 illustrating the functions of some principal elements thereof.

The example of FIG. 6 shows the use of a microcontroller 10, of type Pic 12CE519, which, in addition to a reduced size − necessary for introducing the circuit in the light bulb − , is equipped with an EEPROM memory (not volatile memory) used for recording the code of the key of the remote control chosen for this function.

When circuit 100 is supplied with voltage, the software in it residing activates immediately an output which drives the gate of a TRIAC 11 turning on the lamp 12 and setting the light intensity that it had when it was turned off the last time by cutting off voltage: this way the lamp 12 works as a normal light bulb that can be turned on and off directly by the manual switch present in the apparatus and already used for this function.

In this first step, i.e. when the light bulb 12 is turned on, the circuit 100 starts a self-learning loop for a period T1 (for example 10 seconds). In this period, if a code is sent to the microcontroller, this is stored in the EEPROM of microcontroller 10 same. After that time T1 has lapsed, the software starts a normal operation routine; once detected a code by remote control 5, it is compared with the recorded code present in the memory and, if it is identical, the on/off status of light bulb 12 is switched. When sending a code a key of the remote control is pressed, and if the sending step is longer than said predetermined time, the microcontroller 10 starts adjusting the duty cycle and the intensity of the light bulb is changed; once reached a desired intensity the key of the remote control is released and the intensity value is recorded in the EEPROM of the microcontroller and remains the same up to a further change. The EEPROM has the property of keeping the data even when electric voltage is interrupted, and this assures to the circuit the possibility of turning on again the light maintaining the previously set light intensity and recognizing the same key of the remote control. When sending again a code to the microcontroller within the self-learning period T1, it replaces the previous code present in the memory; this feature allows the device to be programmed in a flexible way concerning the choice of the key that can be used for this function.

The circuit 100 essentially comprises three sections: a feeding section, a control section and a power section.

In particular, the feeding section is supplied by the voltage at the bulb socket; a condenser 15, characterised by a capacitive reactance, transforms the network voltage from 200 Vac to 24 Va; a diode bridge 16 rectifies the voltage, whereas an equalizing condenser 17 along with a resistance 18 and a Zener diode 19 equalize the feeding voltage at +5,6V necessary for feeding the microcontroller 10 and the receiver IR 20.

The control section comprises an amplified IR receiver 20, for example of TSOP18type, and microcontroller 10. The signal received by the IR receiver 20 is amplified and turned into a square wave by the same receiver and then sent to microcontroller 10 which, once verified the admissibility of the code, through output line 21 drives the power section through the gate of Triac 11, which operates as a switch for turning on or off the lamp. Furthermore, if a PWM modulation technique is used, it is possible to adjust the duty cycle of the voltage on the lamp thus allowing the light intensity variation.

A useful function of the software of microcontroller 10 is that of turning off the lamp 12 if it remains turned on for a predetermined time T (for example about 24 hour), in order to save energy (if the lamp is forgotten turned on).

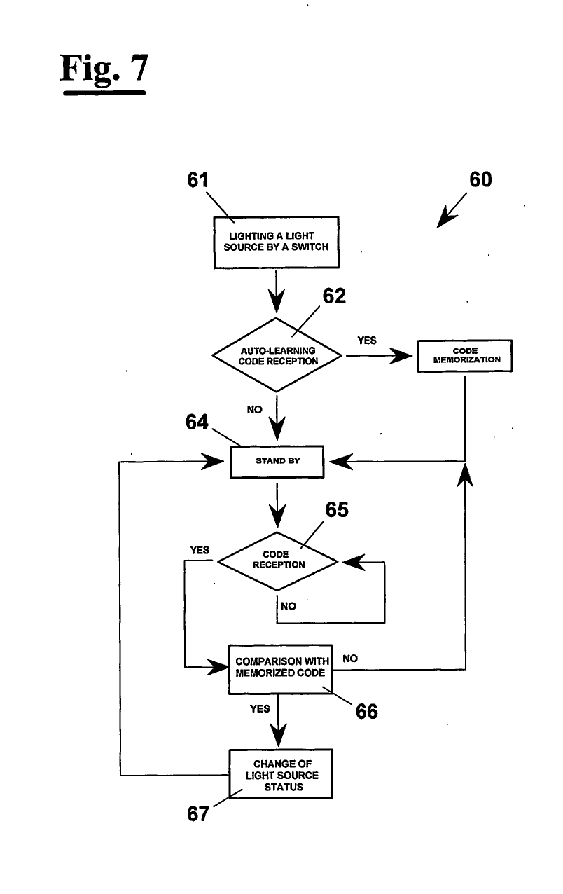

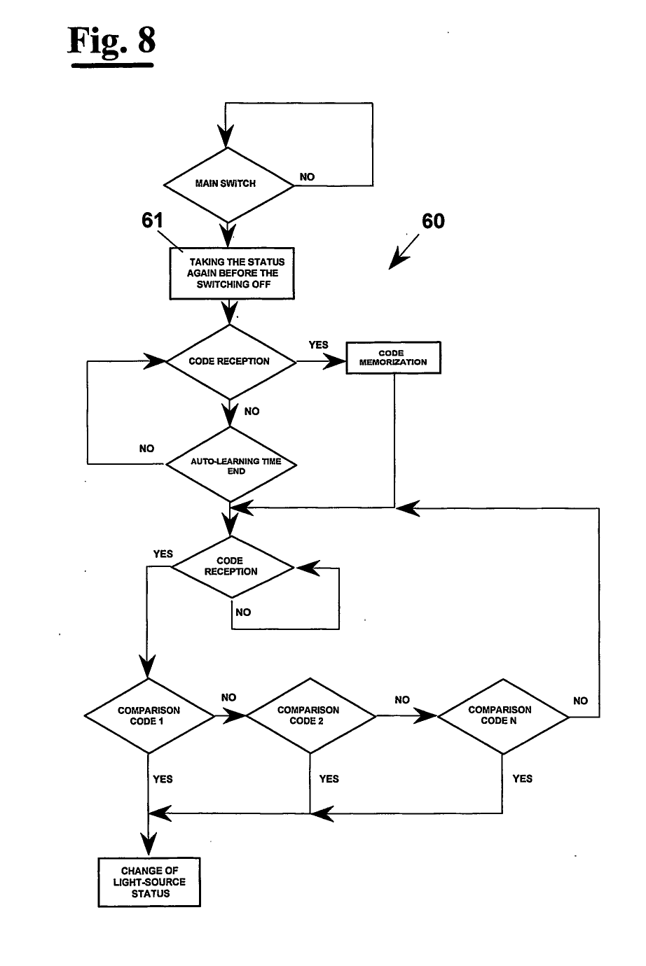

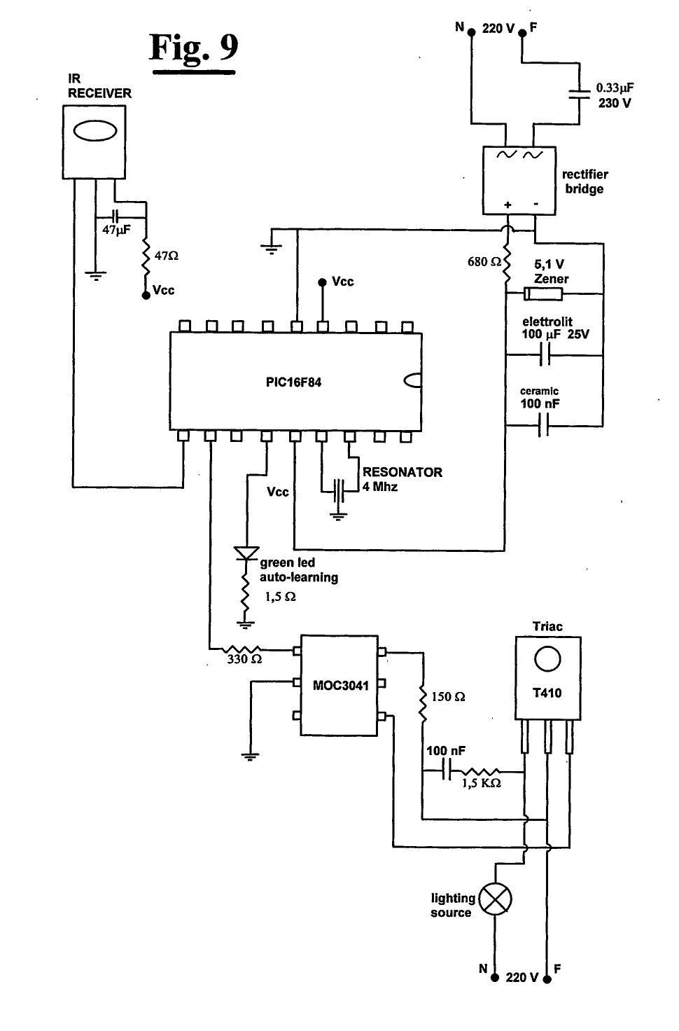

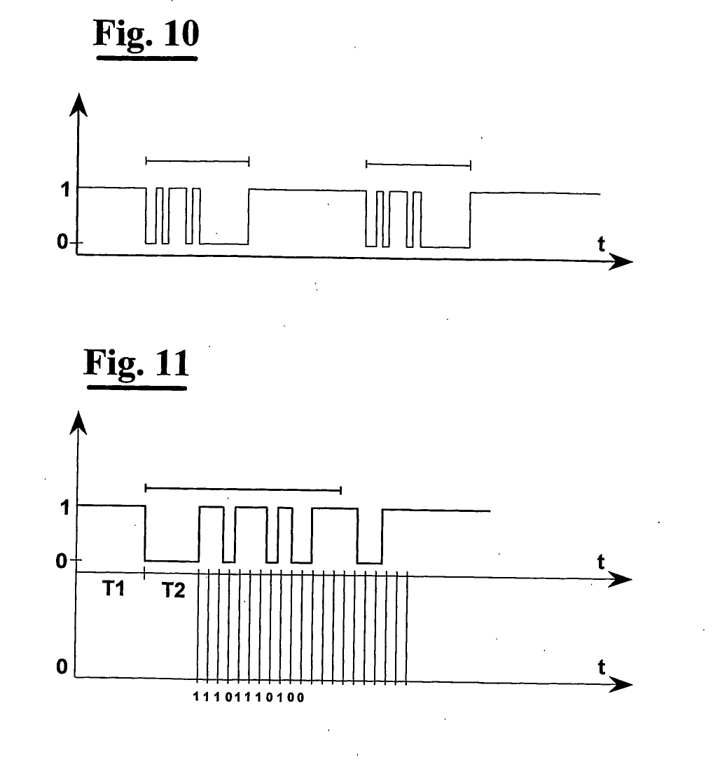

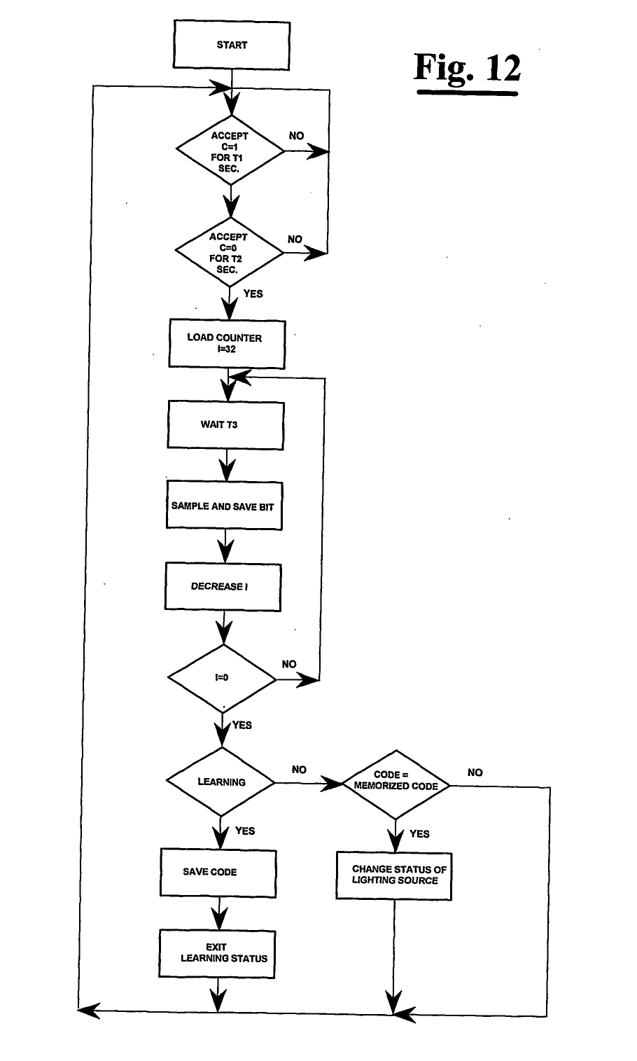

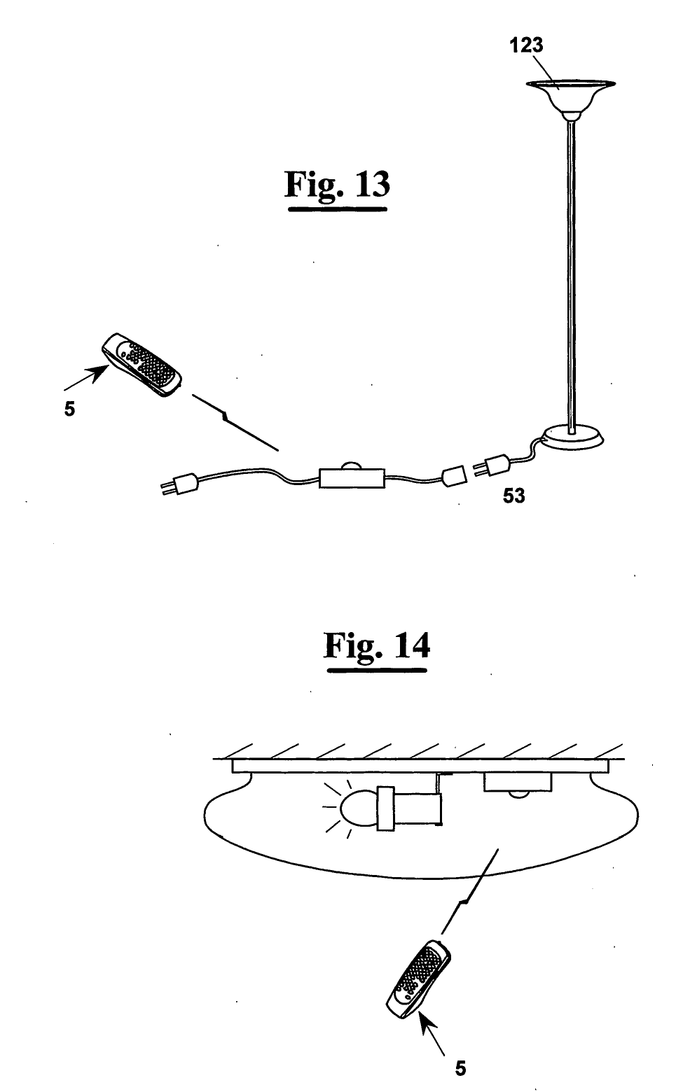

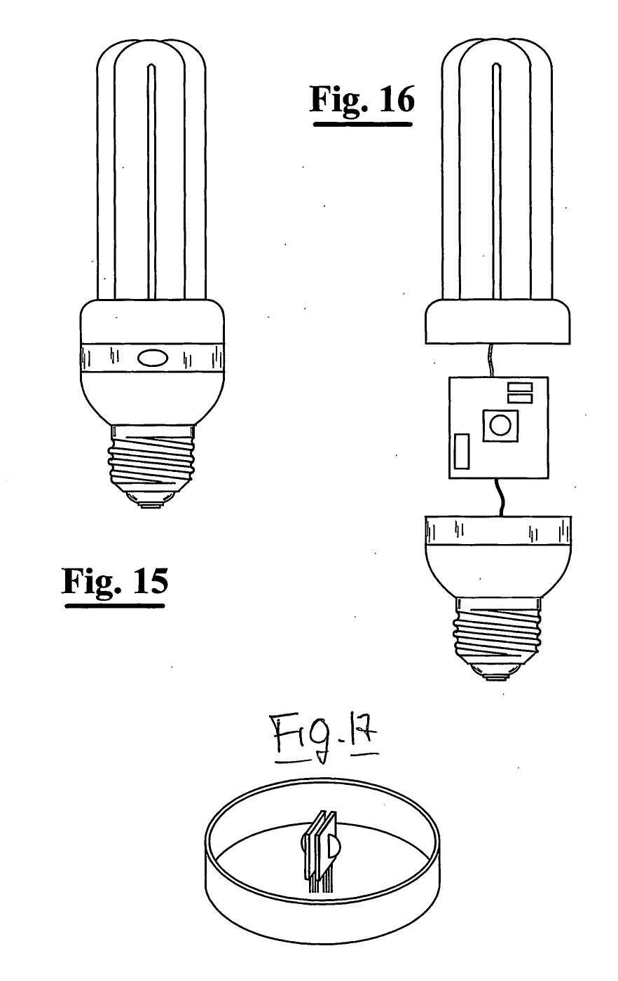

In flow-sheet 60 of FIG. 7 the succession of steps is shown for turning on/off the light source with device 1. The software residing in device 1 provides a starting step with the application of voltage to the circuit when switching on the light source, block 61. This starts the self-learning procedure for a predetermined time during which device 1 awaits an IR code, block 62.

In particular, if during the self-learning time the circuit detects an IR code, the IR code is recorded, block 63. Once ended the self-learning time or once recorded the code a loop is started waiting an IR code coming from the remote control 5, blocks 64 and 65.

When a code is detected it is compared with the code already recorded, block 66. If the codes are identical, the light source is switched, block 67. In the contrary, the circuit returns to the waiting condition.

In figures from 8 to 17 further exemplary embodiments of the invention are shown.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1-17. (canceled)

18. Light bulb comprising one or more apparatus allowing the switching on/off of said light bulb, such apparatus comprising:
at least one receiver capable of detecting an IR code sent by remote control,
means for storing said code associated to said receiver;
means for turning off/on the light.

19. Light bulb according to claim 18 comprising a plurality of said receivers arranged peripherically at a fixed angular distance.

20. Light bulb socket comprising a lighting device allowing the switching on/off of said light bulb, such lighting device comprising:
a receiver capable of detecting an IR code sent by remote control,
means for storing said code associated to said receiver;
means for turning off/on the light.

21. Light bulb socket according to claim 20 comprising a plurality of said receivers arranged peripherically at a fixed angular distance.

22. Light bulb according to claim 18 wherein said means are provided for automatically turning off the light after a predetermined time.

23. Light bulb socket according to claim 20 wherein said means are provided for automatically turning off the light after a predetermined time.

24. Light bulb according to claim 18 wherein said means for storing the IR code comprise learning means of said code, said learning means being switched on for receiving said code in a predetermined situation and for a predetermined time.

25. Light bulb socket according to claim 20 wherein said means for storing the IR code comprise learning means of said code, said learning means being switched on for receiving said code in a predetermined situation and for a predetermined time.

26. Light bulb according to claim 18 wherein said means for storing the IR code are capable of changing the intensity of the light.

27. Light bulb socket according to claim 20 wherein said means for storing the IR code are capable of changing the intensity of the light.
